(19) United States
(12) Patent Application Publication
(10) Pub. No.: US 2026/0078684 A1
(43) Pub. Date: Mar. 19, 2026

(54) SEALING ASSEMBLY AND GAS TURBINE

(71) Applicant: DOOSAN ENERBILITY CO., LTD., Changwon (KR)

(72) Inventors: Seung Yeob LEE, Seoul (KR); Dongkwon Kim, Daejeon (KR); Jaemin Lee, Changwon (KR); Seon Ho Kim, Seongnam (KR)

(21) Appl. No.: 19/326,537

(22) Filed: Sep. 11, 2025

(30) Foreign Application Priority Data
Sep. 19, 2024 (KR) 10-2024-0126536

(51) Int. Cl. F01D 11/00

(52) U.S. Cl. CPC F01D 11/005; F01D 11/003; F05D 2240/11; F05D 2240/55

(57) ABSTRACT

Disclosed is a sealing assembly. The sealing assembly includes a first sealing part that seals a first target sealing part defined along a first direction, a second sealing part that seals a second target sealing part defined along a second direction that crosses the first direction, and is provided adjacent to an end of the first sealing part for connection thereto, and a first extending sealing part that integrally extends from the end of the first sealing part, is configured to be bent, is disposed to cover a gap between the first sealing part and the second sealing part, and is connected to the second sealing part. Accordingly, a structure and an assembling process may be simplified while a sealing performance thereof is enhanced.

### CROSS-REFERENCE TO RELATED APPLICATION

This application claims the benefit of priority to Korean Patent Application No. 10-2024-0126536, filed in the Korean Intellectual Property Office on September 19, 2024, the entire contents of which are incorporated herein by reference.

### TECHNICAL FIELD

The present disclosure relates to a sealing assembly and a gas turbine, and more particularly, to a sealing assembly, of which a structure and an assembling process may be simplified while a sealing performance thereof is enhanced, and a gas turbine including the same.

### BACKGROUND

A turbine is a mechanical apparatus that obtains rotational force with impulse or reaction power by using a flow of a compressible fluid, such as steam or gas, and examples thereof include a steam turbine using steam and a gas turbine using high-temperature combustion gas.

A gas turbine is configured to convert thermal energy into mechanical energy by injecting high-temperature and high-pressure combustion gas that is generated by burning a mixture of high-pressure compressed air compressed by a compressor, and fuel, into a turbine to rotate the turbine.

More specifically, a gas turbine includes a compressor that compresses air, a burner that burns compressed air supplied from the compressor and fuel to generate combustion gas, and a turbine that rotates a rotor via turbine blades that are rotated by high-temperature and high-pressure combustion gas discharged from the burner.

Furthermore, a plurality of ring segments defining a tip clearance between the turbine casing and the turbine blades while preventing leakage of high-pressure cooling air into an inside of the turbine casing or preventing leakage of the combustion gas are provided along a circumferential direction of a turbine casing that accommodates the turbine blades in an interior thereof, to surround outskirts of turbine blades, in an interior of the turbine casing.

Meanwhile, when cooling air is leaked through a gap between adjacent components (for example, adjacent ring segments) of the turbine, the ring segments may be damaged (shortened lifespan) or broken due to thermal load, and the efficiency of the gas turbine may decrease, and thus, it is necessary to minimize leakage of the cooling air through the gap between the adjacent ring segments.

Accordingly, conventionally, a scheme of providing a plurality of sealing members, such as a horizontal sealing member and a vertical sealing member, has been proposed to seal a bent target sealing part between adjacent ring segments along directions that cross each other has been proposed.

However, conventionally, because different types of sealing members are disposed to cross each other between adjacent ring segments, a gap is generated between the different sealing members, and a separate blocking member (an additional sealing member) has to be additionally provided to block the gap between the different sealing part materials, resulting in complicated structure and assembly process, and increased costs.

Accordingly, in recent years, various studies for simplifying the structure and assembling process while securing sealing performance between components of the turbine, such as minimizing leakage of cooling air, have been conducted, but these studies are still insufficient, and development thereof is required.

### SUMMARY

The present disclosure has been made to solve the above-mentioned problems occurring in the prior art while advantages achieved by the prior art are preserved.

An aspect of the present disclosure provides a sealing assembly, of which a structure and an assembling process may be simplified and of which a sealing performance may be enhanced, and a gas turbine including the same.

In particular, an embodiment of the present disclosure aims to simplify structure and manufacturing efforts while securing sealing performance between adjacent components of a turbine.

Above all, an embodiment of the present disclosure aims to effectively seal a gap between sealing members that cross each other without additionally providing a separate blocking member (an additional sealing member) for blocking the gap between the sealing members that cross each other.

Furthermore, an embodiment of the present disclosure aims to save costs and enhance stability and reliability.

The technical problems to be solved by the present disclosure are not limited to the aforementioned problems, and any other technical problems not mentioned herein will be clearly understood from the following description by those skilled in the art to which the present disclosure pertains.

According to a preferred embodiment of the present disclosure, a sealing assembly includes a first sealing part that seals a first target sealing part defined along a first direction, a second sealing part that seals a second target sealing part defined along a second direction that crosses the first direction, and is provided adjacent to an end of the first sealing part for connection thereto, and a first extending sealing part that integrally extends from the end of the first sealing part, configured to be bent, is disposed to cover a gap between the first sealing part and the second sealing part, and is connected to the second sealing part.

This is to simplify the structure and assembly process of a gas turbine and to improve sealing performance.

That is, in the related art, to seal a bent target sealing part between adjacent ring segments, a plurality of different sealing members are disposed to cross each other, so that a gap is generated between the different sealing members, and because an additional blocking member (sealing member) has be further provided to block the gap between the different sealing members, the structure and assembly process become complicated and the costs increase.

However, according to an embodiment of the present disclosure, by allowing a gap between the first sealing part and the second sealing part that cross each other to be covered by the first extending sealing part that integrally extends from the first sealing part, the gap between the first sealing part and the second sealing part may be effectively blocked without using an additional blocking member for blocking the gap, thereby simplifying the structure and assembly process.

Furthermore, according to an embodiment of the present disclosure, by allowing the first sealing part and the second sealing part to be structurally connected to each other via the first extending sealing part, the first sealing part and the second sealing part may be modularized and supplied as a single component, thereby simplifying the assembly process of the first sealing part and the second sealing part and improving assembly efficiency and workability.

The first sealing part may be provided in various structures that may seal or block the first target sealing part.

According to a preferred embodiment of the present disclosure, the first sealing part may include a first cloth layer that is provided along the first direction, a first shim sheet that is stacked on the first cloth layer, and a first elastic plate that is stacked on the first shim sheet, and that elastically supports the first shim sheet against the first target sealing part.

According to a preferred embodiment of the present disclosure, the first shim sheet may include a first shim sheet body part that is stacked on the first cloth layer, and a pair of first shim sheet side parts, each connected to a respective one of opposite side ends of the first shim sheet body part to cover side surfaces of the first cloth layer.

The first elastic plate may be provided in various structures that may elastically support the first shim sheet on the first target sealing part.

According to a preferred embodiment of the present disclosure, the first elastic plate may include a first plate body that is stacked on the first shim sheet, and a pair of first elastic edge parts, each provided at a respective one of opposite side ends of the first plate body, and configured to be bent and to elastically support the first plate body against the first target sealing part.

The second sealing part may be provided in various structures that may seal or block the second target sealing part.

According to a preferred embodiment of the present disclosure, the second sealing part may include a second cloth layer that is provided along the second direction, a second shim sheet that is stacked on the second cloth layer, and a second elastic plate that is stacked on the second shim sheet, and that elastically supports the second shim sheet against the second target sealing part.

According to a preferred embodiment of the present disclosure, the second shim sheet may include a second shim sheet body part that is stacked on the second cloth layer, and a pair of second shim sheet side parts, each connected to a respective one of opposite side ends of the second shim sheet body part to cover side surfaces of the second cloth layer.

The second elastic plate may be provided in various structures that may elastically support the second shim sheet against the second target sealing part.

According to a preferred embodiment of the present disclosure, the second elastic plate may include a second plate body that is stacked on the second shim sheet, and a pair of second elastic edge parts, each provided at a respective one of opposite side ends of the second plate body, and configured to be bent and to elastically support the second plate body against the second target sealing part.

The first extending sealing part may integrally extend from an end of the first sealing part, configured to be bent so as to cover the gap between the first target sealing part and the second target sealing part, that is, the gap between the first sealing part and the second sealing part, and the first sealing part and the second sealing part may be structurally connected to each other via the first extending sealing part.

According to a preferred embodiment of the present disclosure, the first extending sealing part may integrally extend from an end of the first shim sheet.

The first sealing part and the second sealing part may be structurally connected to each other via the first extending sealing part.

Here, the expression "the first sealing part and the second sealing part being structurally connected to each other via the first extending sealing part" may be understood as being modularized into a single component via the first extending sealing part.

The first extending sealing part may be connected to various portions of the second sealing part according to required conditions and design specifications. According to a preferred embodiment of the present disclosure, the first extending sealing part may be supported by the second elastic plate.

The first extending sealing part may be connected to the second elastic plate in various ways according to required conditions and design specifications.

According to a preferred embodiment of the present disclosure, the first extending sealing part may be inserted between the second plate body and the second elastic edge part to structurally connect the first sealing part and the second sealing part.

In this way, according to an embodiment of the present disclosure, by allowing the first extending sealing part to be inserted between the second plate body and the second elastic edge part that are provided to elastically support the second shim sheet on the second target sealing part, it is not necessary to additionally provide a separate structure or component for structurally connecting the first extending sealing part and the second elastic plate, thereby simplifying the connection structure between the first extending sealing part and the second elastic plate and simplifying the manufacturing and assembly processes.

According to a preferred embodiment of the present disclosure, the sealing assembly may include a third sealing part that seals a third target sealing part defined along a third direction that crosses the second direction, and is provided adjacent to an end of the second sealing part for connection thereto.

The third sealing part may be provided in various structures that may seal or block the third target sealing part.

According to a preferred embodiment of the present disclosure, the third sealing part may include a third cloth layer that is provided along the third direction, a third shim sheet that is stacked on the third cloth layer, and a third elastic plate that is stacked on the third shim sheet, and that elastically supports the third shim sheet on the third target sealing part.

According to a preferred embodiment of the present disclosure, the third shim sheet may include a third shim sheet body part that is stacked on the third cloth layer, and a pair of third shim sheet side parts, each connected to a respective one of opposite side ends of the third shim sheet body part to cover side surfaces of the third cloth layer.

The third elastic plate may be provided in various structures that may elastically support the third shim sheet against the third target sealing part.

According to a preferred embodiment of the present disclosure, the third elastic plate may include a third plate body that is stacked on the third shim sheet, and a pair of third elastic edge parts, each provided at a respective one of opposite side ends of the third plate body, and configured to be bent and to elastically support the third plate body against the third target sealing part.

According to a preferred embodiment of the present disclosure, the sealing assembly may include a second extending sealing part that integrally extends from the end of the third sealing part, is configured to be bent, is disposed to cover a gap between the second sealing part and the third sealing part, and is connected to the second sealing part.

According to a preferred embodiment of the present disclosure, the second extending sealing part may integrally extend from an end of the third shim sheet.

The second extending sealing part may be connected to various portions of the second sealing part according to required conditions and design specifications.

According to a preferred embodiment of the present disclosure, the second extending sealing part may be supported by the second elastic plate.

The second extending sealing part may be connected to the second elastic plate in various ways according to required conditions and design specifications.

According to a preferred embodiment of the present disclosure, the second extending sealing part may be inserted between the second plate body and the pair of second elastic edge parts to structurally connect the third sealing part and the second sealing part.

In this way, according to an embodiment of the present disclosure, by allowing the second extending sealing part to be inserted between the second plate body and the pair of second elastic edge parts that are provided to elastically support the second shim sheet on the second target sealing part, it is not necessary to additionally provide a separate structure or component for structurally connecting the second extending sealing part and the second elastic plate, thereby simplifying the connection structure between the second extending sealing part and the second elastic plate and simplifying the manufacturing and assembly processes.

According to another preferred embodiment of the present disclosure, a sealing assembly may include a first sealing part that seals a first target sealing part defined along a first direction, a second sealing part that seals a second target sealing part defined along a second direction that crosses the first direction, and is provided adjacent to an end of the first sealing part for connection thereto, a third sealing part that seals a third target sealing part defined along a third direction that crosses the second direction, and is provided adjacent to an end of the second sealing part for connection thereto, a first extending sealing part that integrally extends from the end of the first sealing part, is configured to be bent, is disposed to cover a gap between the first sealing part and the second sealing part, and is connected to the second sealing part, and a second extending sealing part that integrally extends from the end of the third sealing part, is configured to be bent, is disposed to cover a gap between the second sealing part and the third sealing part, and is connected to the second sealing part.

the first sealing part may include a first cloth layer that is provided along the first direction, a first shim sheet having the first extending sealing part integrally extending from one end thereof and stacked on the first cloth layer, and a first elastic plate that is stacked on the first shim sheet and that elastically supports the first shim sheet against the first target sealing part, the second sealing part may include a second cloth layer that is provided along the second direction, a second shim sheet that is stacked on the second cloth layer, and a second elastic plate that is stacked on the second shim sheet and that elastically supports the second shim sheet against the second target sealing part, and the third sealing part includes a third cloth layer that is provided along the third direction, a third shim sheet having the second extending sealing part integrally extending from one end thereof and that is stacked on the third cloth layer, and a third elastic plate stacked on the third shim sheet and that elastically supports the third shim sheet against the third target sealing part, and the first extending sealing part and the second extending sealing part may each be supported by the second elastic plate.

According to another preferred embodiment of the present disclosure, the second elastic plate may include a second plate body that is stacked on the second shim sheet, and a pair of second elastic edge parts, each provided at a respective one of opposite side ends of the second plate body, and configured to be bent and to elastically support the second plate body on the second target sealing part, and the first extending sealing part and the second extending sealing part may be inserted between the second plate body and the pair of second elastic edge parts.

According to another preferred embodiment of the present disclosure, a gas turbine includes a compressor that suck in and compresses air, a burner that mixes the air compressed in the compressor and fuel to burn the fuel, a turbine including a turbine casing, a plurality of turbine vanes provided on an inner surface of the turbine casing along a circumferential direction thereof, and a plurality of ring segments provided on an inner surface of the turbine casing along the circumferential direction thereof to face turbine blades that are rotatably provided in the interior of the turbine casing, and that rotates the turbine blades by combustion gas discharged from the burner, a first sealing part that seals a first target sealing part defined between adjacent ring segments of the plurality of ring segments or adjacent turbine vanes of the plurality of turbine vanes along a first direction, a second sealing part that seals a second target sealing part defined between the adjacent ring segments or the adjacent turbine vanes along a second direction crossing the first direction, and is provided adjacent to an end of the first sealing part for connection thereto, and a first extending sealing part that integrally extends from the end of the first sealing part, is configured to be bent, is disposed to cover a gap between the first sealing part and the second sealing part, and is connected to the second sealing part.

According to another preferred embodiment of the present disclosure, the first sealing part may include a first cloth layer that is provided along the first direction, a first shim sheet that is stacked on the first cloth layer, and a first elastic plate that is stacked on the first shim sheet, and that elastically supports the first shim sheet against the first target sealing part, and the first extending sealing part may integrally extend from an end of the first shim sheet.

According to another preferred embodiment of the present disclosure, the second sealing part may include a second cloth layer that is provided along the second direction, a second shim sheet that is stacked on the second cloth layer, and a second elastic plate that is stacked on the second shim sheet, and that elastically supports the second shim sheet against the second target sealing part, and the first extending sealing part may be supported by the second elastic plate.

According to another preferred embodiment of the present disclosure, the second elastic plate may include a second plate body stacked on the second shim sheet, a pair of second elastic edge parts, each provided at a respective one of opposite side ends of the second plate body, and configured to be bent and to elastically support the second plate body against the second target sealing part, and the first extending sealing part may be inserted between the second plate body and the pair of second elastic edge parts.

### BRIEF DESCRIPTION OF THE DRAWINGS

The above and other objects, features and advantages of the present disclosure will be more apparent from the following detailed description taken in conjunction with the accompanying drawings:

FIG. 1 are views illustrating a gas turbine according to an embodiment of the present disclosure;

FIG. 2 is a view illustrating a gas turbine according to an embodiment of the present disclosure, and illustrates a ring segment; and

FIGS. 3 to 5 are views illustrating a sealing assembly according to an embodiment of the present disclosure.

### DETAILED DESCRIPTION

Hereinafter, embodiments of the present disclosure will be described in detail with reference to the accompanying drawings

However, the technical spirit of the present disclosure is not limited some embodiments, and may be implemented in various different forms, and one or more of the components of the embodiments may be selectively coupled to each other or replaced with each other to be used without departing from the technical spirit of the present disclosure.

Furthermore, the terms (including technical and scientific terms) used in the embodiments of the present disclosure may be construed as meanings that may be generally understood to those skilled in the art, to which the present disclosure pertains, unless particularly defined and described clearly.

Furthermore, the terms used in the embodiments of the present disclosure are provided to describe embodiments, not intended to limit the present disclosure.

In the specification, a singular form may include a plural form unless particularly mentioned in the context, and an expression “at least one (one or more) of A, B, and C” may include one or more of all combinations of A, B, and C.

In describing components of the embodiments of the present disclosure, the terms first, second, A, B, (a), (b), and the like may be used herein.

These terms are only used to distinguish one component from another component, but do not limit the corresponding components irrespective of the nature, order, or priority of the corresponding components.

Furthermore, when it is described that a component is ‘connected to’, ‘coupled to’, or ‘electrically connected to’ a second component, the component may not only be directly connected to, coupled to, or electrically connected to the second component, but also be ‘connected to’, ‘coupled to’, or ‘electrically connected to’ the second component due to a third component therebetween.

Furthermore, when it is described that a component is formed or disposed “on an upper side of (above) or on a lower side of (under)” a second component, the two components may not only directly contact each other but also a third component may be formed or disposed between the two components. Furthermore, the expression “on an upper side of (above) or on a lower side of (under)” may mean not only an upward direction but also a downward direction with respect to one component.

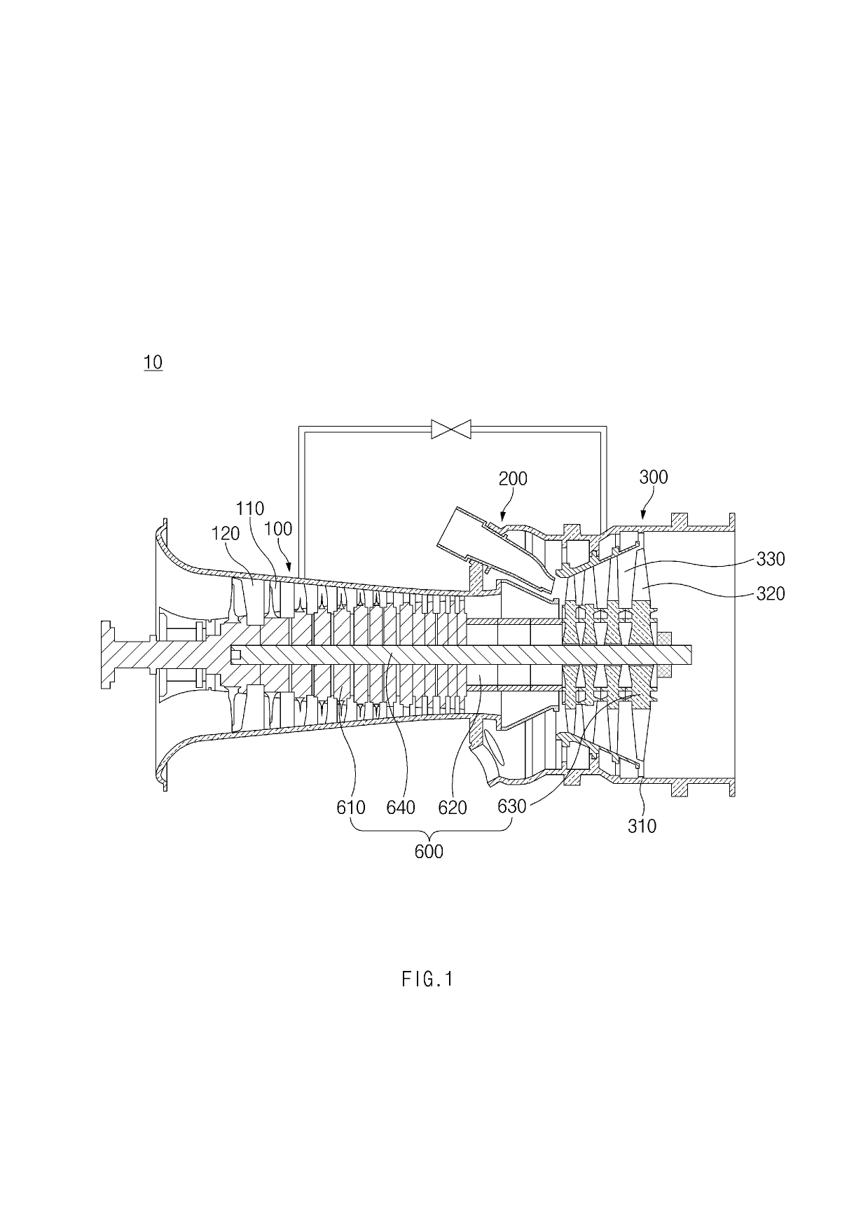

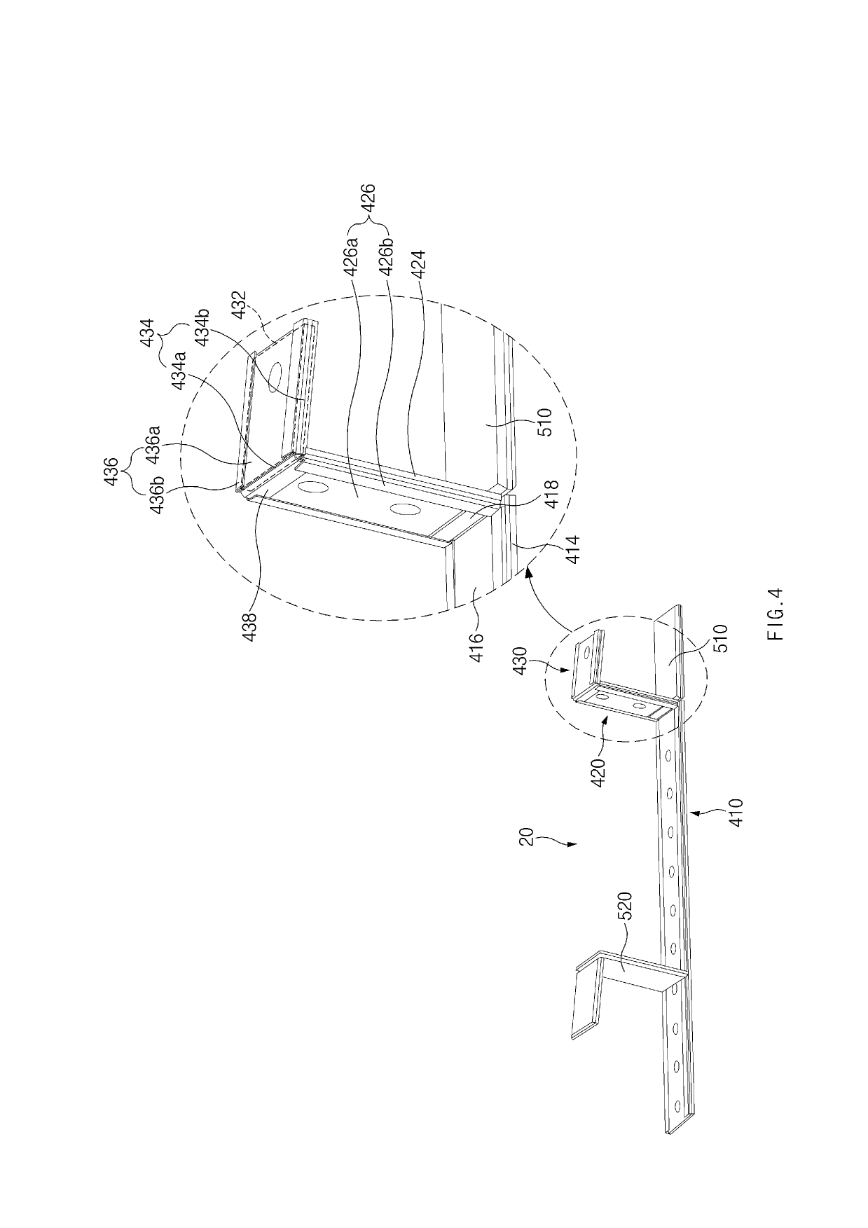

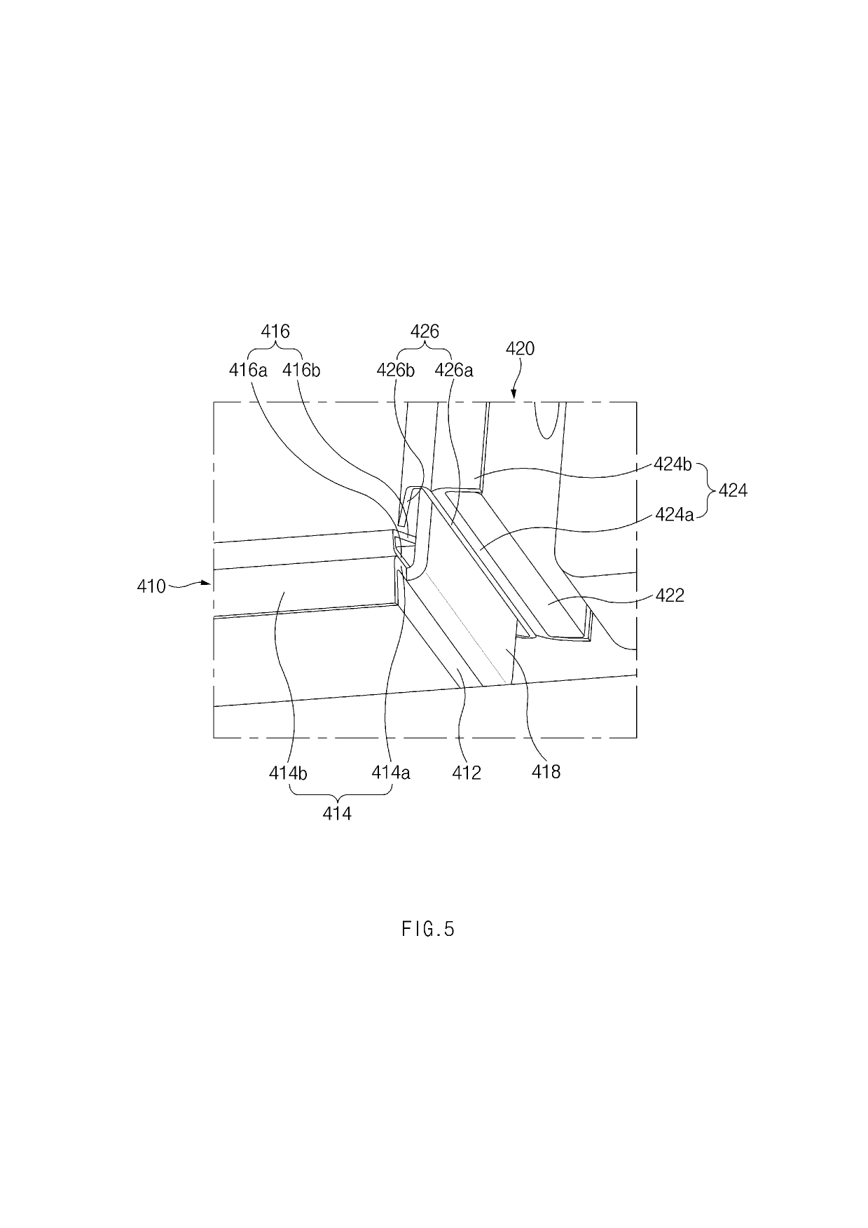

Referring to FIGS. 1 to 5, a sealing assembly 20 according to an embodiment of the present disclosure includes a first sealing part 410 that seals a first target sealing part defined along a first direction, a second sealing part 420 that seals a second target sealing part defined along a second direction that crosses the first direction and is provided adjacent to an end of the first sealing part 410 for connection thereto, and a first extending sealing part 418 that integrally extends from an end of the first sealing part 410, is configured to be bent, is disposed to cover a gap between the first sealing part 410 and the second sealing part 420, and is connected to the second sealing part 420.

The sealing assembly 20 may be used to seal or block a target sealing part of various objects depending on required conditions and design specifications, and the present disclosure is neither limited nor restricted by a type or structure of the object, to which the sealing assembly 20 is applied.

Hereinafter, an example, in which the sealing assembly 20 according to an embodiment of the present disclosure is applied to a gas turbine 10 including a compressor 100, a burner 200, and a turbine 300 will be described.

For reference, the gas turbine 10 is configured to, after suctioning air in the atmosphere and compressing the air at a high pressure, burn a fuel in a static pressure environment to emit thermal energy, and expand this high-temperature combustion gas to convert it into kinetic energy.

Referring to FIGS. 1 to 3, the gas turbine 10 according to a preferred embodiment of the present disclosure includes a compressor 100 that sucks in and compresses air, a burner 200 that mixes the air compressed in the compressor 100 and fuel to burn the fuel, a turbine 300 including a turbine casing 310, a plurality of turbine vanes 330 provided on an inner surface of the turbine casing 310 along a circumferential direction thereof, and a plurality of ring segments 340 provided on an inner surface of the turbine casing 310 along the circumferential direction thereof to face turbine blades 320 that are rotatably provided in the interior of the turbine casing 310, and that rotates the turbine blades 320 by combustion gas discharged from the burner 200, a first sealing part 410 that seals a first target sealing part defined between adjacent ring segments 340 of the plurality of ring segments 340 or adjacent turbine vanes 330 of the plurality of turbine vanes 330 along a first direction, a second sealing part 420 that seals a second target sealing part defined between the adjacent ring segments 340 of the plurality of ring segments 340 or the adjacent turbine vanes 330 of the plurality of turbine vanes 330 along a second direction crossing the first direction, and provided adjacent to an end of the first sealing part 410 for connection thereto, and a first extending sealing part 418 that integrally extends from the end of the first sealing part 410, is configured to be bent, is disposed to cover a gap between the first sealing part 410 and the second sealing part 420, and is connected to the second sealing part 420.

The compressor 100 is configured to suck in air from the outside and compress the air.

As an example, the compressor 100 may supply cooling air to a high-temperature area of the gas turbine 20, which requires cooling, while supplying compressed air that is compressed by compressor blades 110 to the burner 200.

Various compressors 100 may be used as the compressor 100 according to required conditions and design specifications, and the present disclosure is neither limited nor restricted by the type and structure of the compressor 100.

As an example, the compressor 100 may be designed as a centrifugal compressor or an axial compressor. A centrifugal compressor may be used in a small-sized gas turbine and a multi-stage axial compressor may be used in a large-sized gas turbine.

According to a preferred embodiment of the present disclosure, the compressor 100 may include a compressor blade 110 that is rotated together with a rotor 600 and a compressor vane 120 that is installed in a compressor casing (not illustrated) to align flow of the air that is introduced into the compressor blade 110.

For reference, the rotor 600 may include a compressor rotor disk 610 that is accommodated in a compressor casing (not illustrated), a turbine rotor disk 630 that is accommodated in the turbine casing 310, a torque tube 620 that is accommodated in a burner casing (not illustrated) and connects the compressor rotor disk 610 and the turbine rotor disk 630, a tie rod 640 and a fixing nut (not illustrated) that fasten the compressor rotor disks 610, the torque tube 620, and the turbine rotor disk 630.

As an example, a plurality of compressor rotor disks 610 (e.g., 14 disks) may be formed, and the plurality of compressor rotor disks 610 may be arranged along an axial direction of the rotor 600. That is, the compressor rotor disks 610 may be formed in multiple stages.

Furthermore, each compressor rotor disk 610 may be formed in a substantially disk shape, and compressor blade coupling slots (not illustrated), to which the compressor blades 110 to be described later are coupled, may be formed at an outer periphery of the compressor rotor disk 610.

The turbine rotor disk 630 may be formed similarly to the compressor rotor disk 610. That is, a plurality of turbine rotor disks 630 may be formed, and may be arranged in multiple stages along the axial direction of the rotor 600.

The turbine rotor disk 630 may be formed in a substantially disk shape, and turbine blade coupling slots (not illustrated), to which turbine blades 320 to be described later are coupled, may be formed at an outer periphery of the turbine rotor disk 630.

The torque tube 620 is a torque transmission member that transmits rotational force of the turbine rotor disk 630 to the compressor rotor disk 610, and one end thereof is fastened to a compressor rotor disk that is located at a most downstream side end in an airflow direction, among the plurality of compressor rotor disks 610, and an opposite end thereof is fastened to a turbine rotor disk 630 that is located at a most upstream side end in a combustion gas flow direction, among the plurality of turbine rotor disks 630.

Projections (not illustrated) may be formed at one end and an opposite end of the torque tube 620, respectively, and grooves (not illustrated) that are enmeshed with the projections may be formed in the compressor rotor disks 610 and the turbine rotor disks 630, respectively, such that relative rotation of the torque tube 620 with respect to the compressor rotor disks 610 and the turbine rotor disks 630 may be constrained.

The torque tube 620 may be formed in a substantially hollow cylindrical shape such that air supplied from the compressor 100 may flow to the turbine 300 through the torque tube 620.

Preferably, the torque tube 620 may be formed to have strong characteristics on deformation and torsion due to the characteristics of the gas turbine 10 operated continuously for a long time, and may be configured to be easily assembled and disassembled for easy repair and maintenance.

The tie rod 640 is formed to pass through the plurality of compressor rotor disks 610, the torque tube 620, and the plurality of turbine rotor disks 630, and one end thereof is fastened into a compressor rotor disk that is located at a most upstream side end in an airflow direction, among the plurality of compressor rotor disks 610, and an opposite end thereof protrudes to a side that is opposite to the compressor 100 with respect to the turbine rotor disk 630 that is located at a most downstream side end in a combustion gas flow direction, among the plurality of turbine rotor disks 630, and may be fastened to the fixing nut.

The fixing nut may press the turbine rotor disk 630 located at the most downstream side end toward the compressor 100, and as a distance between the compressor rotor disk 610 located at the most upstream side end and the turbine rotor disk 630 located at the most downstream side end decreases, the plurality of compressor rotor disks 610, the torque tube 620, and the plurality of turbine rotor disks 630 may be compressed in an axial direction of the rotor 600. Accordingly, axial movement and relative rotation of the plurality of compressor rotor disks 610, the torque tube 620, and the plurality of turbine rotor disks 630 may be constrained.

In the above-described and illustrated embodiment of the present disclosure, an example, in which the tie rod passes through the centers of the plurality of compressor rotor disks 610, the torque tube 620, and the plurality of turbine rotor disks 630, is described, but, according to another embodiment of the present disclosure, it is also possible to provide separate tie rods in the compressor 100 and the turbine 300, respectively. Alternatively, the plurality of tie rods 640 may be configured to be disposed radially along a circumferential direction.

Opposite end of the rotor 600 according to this configuration may be supported by bearings to be rotatable, and one end thereof may be connected to a drive shaft of a generator.

A plurality of compressor blades 110 may be formed, and the plurality of compressor blades 110 may be formed in multiple stages along an axial direction of the rotor 600, and the plurality of compressor blades 110 may be formed radially along a rotational direction of the rotor 600 at each stage.

A root part (not illustrated) of the compressor blade 110 is coupled to a compressor blade coupling slot (not illustrated) of the compressor rotor disk 610, and the root part may be formed in a fir-tree shape to prevent the compressor blade 110 from being separated from the compressor blade coupling slot in a radial direction of rotation of the rotor 600. In this case, the compressor blade coupling slot may also be formed in a fir-tree shape corresponding to the root part of the compressor blade 110.

In the above-described and illustrated embodiment of the present disclosure, an example, in which the root part of the compressor blade and the compressor blade coupling slot are formed in a fir-tree shape, is described, but, according to another embodiment of the present disclosure, it is also possible to form the root part of the compressor blade and the compressor blade coupling slot in a dovetail shape or another shape. Alternatively, it is also possible to fasten the compressor blade 110 to the compressor rotor disk 610 by using a separate fastening device, such as a fixing tool of a key or a bolt.

The compressor rotor disk 610 and the compressor blade 110 may generally be coupled in a tangential type or an axial type, and in the embodiment of the present disclosure, the root part of the compressor blade is formed in a so-called axial type, in which it is inserted into the compressor blade coupling slot along an axial direction of the rotor 600, as described above.

Preferably, a plurality of compressor blade coupling slots may be formed, and the plurality of compressor blade coupling slots may be radially arranged along a circumferential direction of the compressor rotor disk 610.

A plurality of compressor vanes 120 may be formed, and the plurality of compressor vanes 120 may be formed in multiple stages along an axial direction of the rotor 600.

Here, the compressor vanes 120 and the compressor blades 110 may be alternately arranged along an airflow direction.

Furthermore, the plurality of compressor vanes 120 may be formed radially along a rotational direction of the rotor 600 at each stage. As an example, at least some of the plurality of compressor vanes 120 may be mounted to be rotatable within a predetermined range to control an intake amount of air.

The burner 200 is configured to generate high-energy combustion gas by mixing the compressed air supplied from the compressor 100 with the fuel and through isobaric combustion.

Various types of burners 200 that may mix compressed air with fuel and burning it may be used, and the present disclosure is neither limited nor restricted by the type or structure of the burner 200.

As an example, a plurality of burners 200 may be provided, and the plurality of burners 200 may be arranged along a rotational direction of the rotor 600 in a burner casing (not illustrated).

The burner 200 may include a liner (not illustrated), into which compressed air compressed by the compressor 100 is introduced, and a transition piece (not illustrated) that is located on a rear side of the liner to guide combustion gas to the turbine 300. The liner and the transition piece form a combustion chamber in an interior thereof, and a sleeve may be disposed to surround the liner and the transition piece to form an annular flow space between them.

Additionally, the burner 200 may include a fuel injection nozzle (not illustrated) that is provided on a front side of the liner to inject a mixture of the compressed air supplied from the compressor 100, and the fuel, and an ignition plug (not illustrated) that is provided on a wall of the liner such that the compressed air and the fuel mixed in the combustion chamber of the liner are ignited. Thereafter, the burned gas is discharged to the turbine 300 to generate rotation.

In this case, cooling the liner and the transition piece exposed to high-temperature and high-pressure combustion gas is important for increasing the durability of the burner 200. To this end, cooling holes (not illustrated) may be formed in the sleeve, and as compressed air that is introduced through the cooling holes collides vertically with outer walls of the liner and the transition piece, the liner and the transition piece may be cooled.

More specifically, the compressed air introduced from the compressor 100 may be introduced into the annular space through the cooling holes formed in the sleeve to cool the liner and the transition piece, may flow toward a front side of the liner along the annular space, and may be introduced into the fuel injection nozzle.

Furthermore, a de-swirler may be provided between the compressor 100 and the burner 200 to serve as a guide wing to adjust a flow angle of the air introduced into the burner 200 to a designed flow angle.

The high-temperature, high-pressure exhaust gas generated in the burner 200 may be supplied to the turbine 300, and in the turbine 300, the thermal energy of the exhaust gas may be converted into mechanical energy, by which a rotary shaft is rotated, by applying a collision and reaction force to a plurality of blades that are radially disposed on the rotary shaft of the turbine 300 while the exhaust gas is adiabatically expanded.

A portion of the mechanical energy generated in the turbine 300 may be utilized as energy that is necessary to compress the air in the compressor 100, and the remaining portions thereof may be utilized as effective energy, for example, to drive a power generator to produce electric power.

The turbine 300 may be formed similarly to the compressor 100. The turbine 300 may include turbine blades 320 that are rotated together with the rotor 600, and turbine vanes 330 that are fixedly installed in the turbine casing 310 to align a flow of the air introduced into the turbine blades 320.

As an example, a plurality of turbine blades 320 may be formed, and the plurality of turbine blades 320 may be formed in multiple stages along an axial direction of the rotor 600, and the plurality of turbine blades 320 may be radially formed along a rotational direction of the rotor 600 at each stage.

Specifically, the turbine blade 320 may include a turbine blade platform part (not illustrated) having a plate shape, a turbine blade root part (not illustrated) that extends centripetally from the turbine blade platform part in a rotational radius direction of the rotor 600, and a turbine blade air foil part (not illustrated) that extends centrifugally from the turbine blade platform part in the rotational radius direction of the rotor 600.

The turbine blade platform part may serve to maintain a gap between the turbine blade air foil parts while contacting an adjacent turbine blade platform part.

The root part of the turbine blade 320 may be coupled to a turbine blade coupling slot of the turbine rotor disk 630, and the root part may be formed in a fir-tree shape to prevent the turbine blade 320 from being separated from the turbine blade coupling slot in a radial direction of rotation of the rotor 600. In this case, the turbine blade coupling slot may also be formed in a fir-tree shape corresponding to the root part of the turbine blade 320. The root part of the turbine blade 320 may be formed in a so-called axial type, in which it is inserted into the turbine blade coupling slot along the axial direction of the rotor 600, as described above.

The turbine blade air foil part may be formed to have a wing shape that is optimized according to the specifications of the gas turbine 10, and may include a leading edge that is located on an upstream side in a flow direction of the combustion gas such that the combustion gas is introduced, and a trailing edge that is located on a downstream side in the flow direction of the combustion gas such that the combustion gas is discharged.

A plurality of turbine vanes 330 may be formed, and the plurality of turbine vanes 330 may be formed in multiple stages along an axial direction of the rotor 600. Here, the turbine vanes 330 and the turbine blades 320 may be alternately arranged along an airflow direction. Furthermore, the plurality of turbine vanes 330 may be radially formed along a rotational direction of the rotor 600 at each stage.

As an example, each turbine vane 330 may be fixedly mounted inside a turbine housing by a vane carrier 350 that is an end wall coupled to an inner end and an outer end of the turbine vane 330.

Unlike the compressor 100, the turbine 300 contacts the high-temperature and high-pressure combustion gas, and thus requires a cooling means for preventing damage, such as thermal degradation. To this end, it may include a cooling passage (not illustrated) for drawing the compressed air from a specific part of the compressor 100 and supplying it to the turbine 300.

As an example, the cooling passage may extend to an outside of a compressor casing (an external passage) or pass through an inside of the rotor 600 (an internal passage), or it is also possible to be used as both the external passage and the internal passage.

The cooling passage may communicate with a turbine blade cooling passage (not illustrated) that is formed inside the turbine blade 320, so that the turbine blade 320 may be cooled by the cooling air. Furthermore, the turbine blade cooling passage may communicate with a turbine blade film cooling hole that is formed on a surface of the turbine blade 320, and the cooling air may be supplied to the surface of the turbine blade 320 so that the turbine blade 320 may be film-cooled by the cooling air. The turbine vane 330 may also be configured to receive the cooling air from the cooling passage in a manner similar to the turbine blade 320 to be cooled.

Meanwhile, the turbine 300 requires a gap between a tip end of the turbine blade 320 and an inner peripheral surface of the turbine casing 310 so that the turbine blade 320 may be smoothly rotated.

However, as the gap between the tip end of the turbine blade 320 and the inner peripheral surface of the turbine casing 310 becomes wider, it becomes more advantageous in terms of preventing interference between the turbine blade 320 and the turbine casing 310, but it is disadvantageous in terms of leakage of the combustion gas, and conversely, the gap becomes narrower, the opposite result occurs.

That is, a flow of the combustion gas that is injected from the burner 200 may be classified into a main flow that passes through the turbine blade 320 and a leakage flow that passes through the gap between the turbine blade 320 and the turbine casing 310, and as the gap becomes wider, the leakage flow increases and the efficiency of the gas turbine 10 decreases, but interference and resulting damage due to thermal deformation between the turbine blade 320 and the turbine casing 310 may be prevented. On the other hand, as the gap (i.e., the gap between the tip end of the turbine blade and the inner peripheral surface of the turbine casing) becomes narrower, the leakage flow may decrease and the efficiency of the gas turbine 10 may be enhanced, but interference and resulting damage due to thermal deformation between the turbine blade 320 and the turbine casing 310 may occur.

Preferably, the gas turbine 10 may include a ring segment 340 to secure an appropriate gap that minimizes a decrease in gas turbine efficiency while preventing interference and resulting damage between the turbine blade 320 and the turbine casing 310.

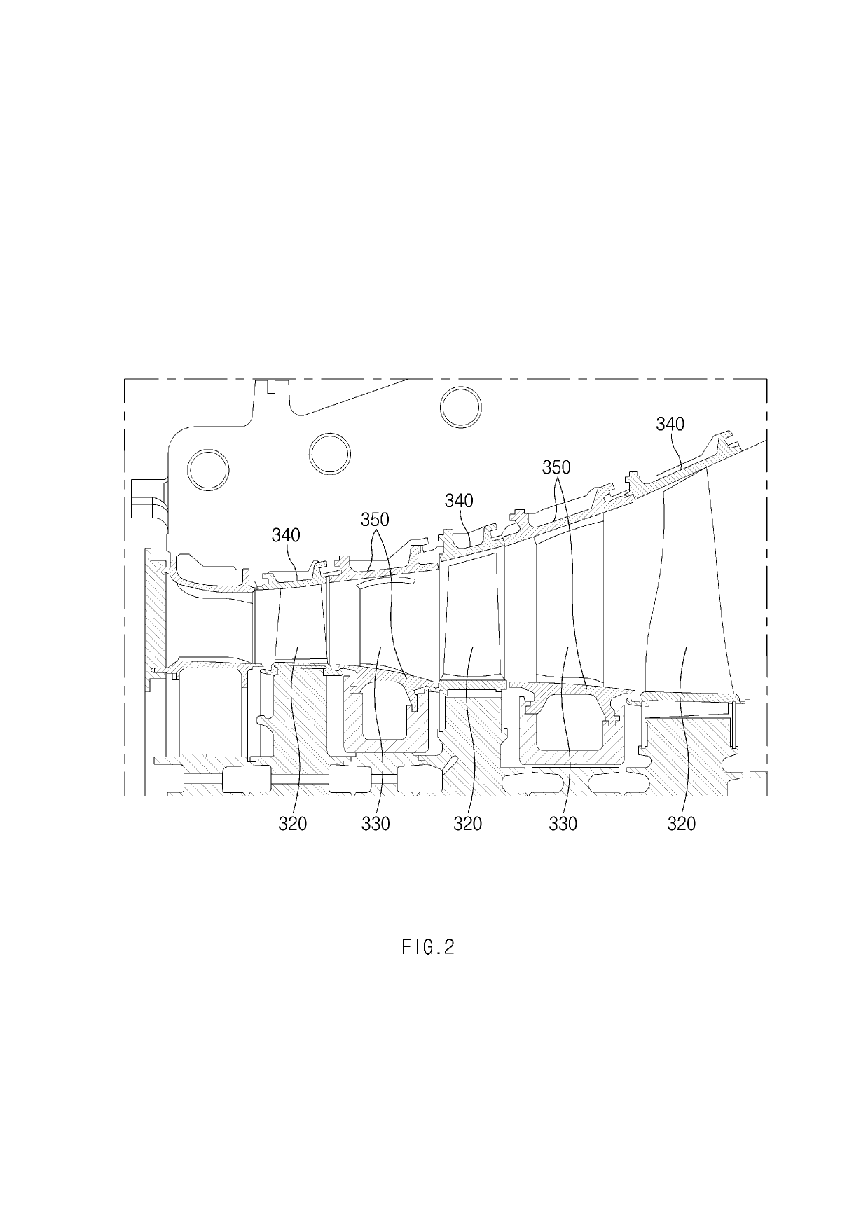

Referring to FIG. 2, the ring segment 340 is installed on the inner peripheral surface of the turbine casing 310 to surround the turbine blade 320. Specifically, a plurality of ring segments 340 are mounted on an inner wall of the turbine casing 310, and the plurality of ring segments 340 are continuously disposed along the circumferential direction of the turbine casing 310 to form a substantially ring shape. The plurality of ring segments 340 that forms a ring shape prevent leakage of the cooling air while surrounding the turbine blade 320 from the outside. That is, the plurality of ring segments 340 that forms a ring shape may be formed in multiple stages corresponding to the positions of the turbine blade 320 in a lengthwise direction of a turbine center axis, and may be disposed alternately with the turbine vanes 330.

As an example, the ring segment 340 may include a shielding plate (not illustrated) that extends along a rotational direction of the rotor 600 while facing the inner wall of the turbine casing 310, and a pair of hook parts (not illustrated) that protrude toward the turbine casing 310 from the shielding plate. The shielding plate may be formed in a substantially rectangular plate shape, and the hook parts may protrude from an outer surface of the shielding plate toward the turbine casing 310 to be bent in a radial direction of the turbine, and may be inserted into grooves formed in the turbine casing 310.

In addition, because the high-temperature and high-pressure combustion gas passes through the inside of the turbine casing 310, damage due to thermal load may occur in the ring segment 340, particularly, at a portion (the inner peripheral surface of the ring segment) of the ring segment 340 that faces the inner space of the turbine casing 310. Accordingly, to prevent this, the ring segment 340 may include a plurality of cooling passages.

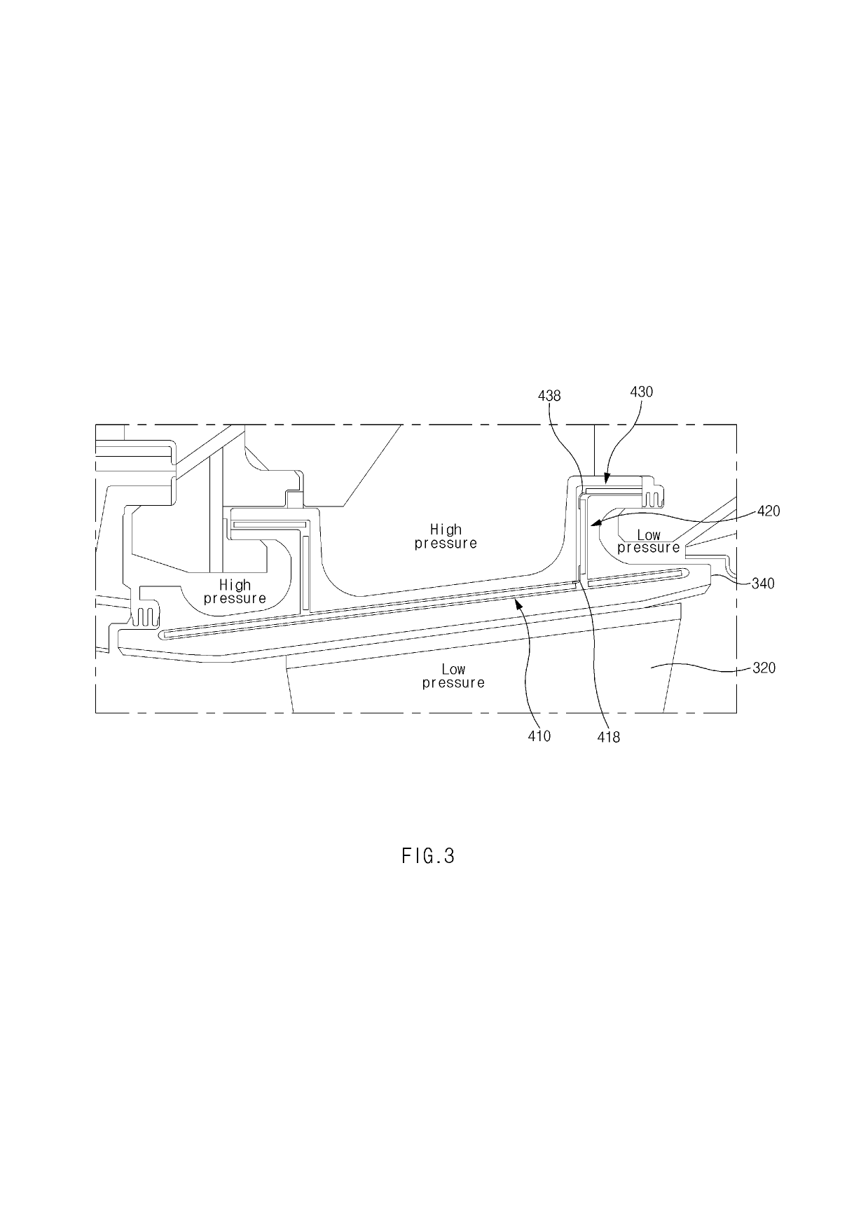

Referring to FIGS. 3 to 5, the sealing assembly 20 is provided to seal or block a gap between turbine components that constitute the turbine 300 of the gas turbine 10, the gap being located at a portion referred to as a target sealing part, and includes a first sealing part 410, a second sealing part 420, and a first extending sealing part 418.

The sealing assembly 20 may be applied between various turbine components according to required conditions and design specifications, and the present disclosure is neither limited nor restricted by the types and structures of the turbine components, to which the sealing assembly 20 is applied.

As an example, the sealing assembly 20 may be provided between adjacent ring segments 340 or between adjacent turbine vanes 330. Hereinafter, an example, in which the sealing assembly 20 is applied between adjacent ring segments 340, will be described.

Here, “between adjacent ring segments 340” may be understood as a gap between ring segments 340 that are adjacent to each other along a circumferential direction of the turbine casing 310.

The first sealing part 410 is provided to seal a first target sealing part that is defined along a first direction between adjacent ring segments 340.

For reference, in the embodiment of the present disclosure, the first target sealing part may be defined as a portion (e.g., a surface to be sealed) that is sealed by the first sealing part 410.

The first target sealing part may be defined in various directions and structures depending on required conditions and design specifications, and the present disclosure is neither limited nor restricted by the direction (the direction of the first sealing part 410) and structure of the first target sealing part.

As an example, the first target sealing part may be defined in a substantially straight line along an axial direction (the first direction) of the turbine. According to another embodiment of the present disclosure, it is also possible to configure the first target sealing part such that it is inclined with respect to the axial direction of the turbine. Alternatively, the first target sealing part may be formed in a curved shape or another shape.

The first sealing part 410 may be provided in various structures that may seal or block the first target sealing part, and the present disclosure is neither limited nor restricted by the structure of the first sealing part 410.

According to a preferred embodiment of the present disclosure, the first sealing part 410 may include a first cloth layer 412 that is provided along the first direction, a first shim sheet 414 that is stacked on the first cloth layer 412, and a first elastic plate 416 that is stacked on the first shim sheet 414 to elastically support the first shim sheet 414 against the first target sealing part.

The first cloth layer 412 is provided to provide flexibility to the first sealing part 410 while securing sealing performance of the first sealing part 410.

The first cloth layer 412 may be formed of various materials having flexibility, and the present disclosure is neither limited nor restricted by the material and properties of the first cloth layer 412.

As an example, the first cloth layer 412 may include at least one of metal, ceramic, and/or polymer fibers that are woven, knitted, or pressed into a textile layer.

The first cloth layer 412 may be provided to have various structures according to required conditions and design specifications, and the present disclosure is neither limited nor restricted by the structure or shape of the first cloth layer 412.

As an example, the first cloth layer 412 may be provided in a substantially rectangular block shape.

The first shim sheet 414 is stacked on one surface of the first cloth layer 412 to form a double sealing structure together with the first cloth layer 412.

The first shim sheet 414 may be formed of various materials that may secure sealing performance, and the present disclosure is neither limited nor restricted by the material or properties of the first shim sheet 414.

As an example, the first shim sheet 414 may be formed of a general metal material. Preferably, the first shim sheet 414 may be formed by machining a thin metal plate to a thickness of 0.127 mm to provide flexibility such that the first sealing part 410 may effectively adhere to a surface of the first target sealing part.

The first shim sheet 414 may be provided in various structures that may be stacked on the first cloth layer 412, and the present disclosure is neither limited nor restricted by the structure of the first shim sheet 414.

According to a preferred embodiment of the present disclosure, the first shim sheet 414 may include a first shim sheet body part 414a that is stacked on the first cloth layer 412 and a pair of first shim sheet side parts 414b, each connected to a respective one of the opposite side ends of the first shim sheet body part 414a to cover corresponding side surfaces of the first cloth layer 412.

As an example, the first shim sheet body part 414a may be formed in a substantially rectangular plate shape corresponding to the first cloth layer 412. Each of the pair of first shim sheet side parts 414b may be continuously formed along a respective one of opposite side ends of the first shim sheet body part 414a, and the first shim sheet body part 414a and each of the first shim sheet side parts 414b may be cooperatively connected to each other to have a substantially “L”-shaped cross section.

In the above-described and illustrated embodiment of the present disclosure, an example, in which each of the pair of first shim sheet side parts 414b is continuously formed along the side end of the first shim sheet body part 414a to entirely cover side surfaces of the first cloth layer 412, is described, but according to another embodiment of the present disclosure, it is also possible to configure the pair of first shim sheet side parts 414b such that it partially covers the side surfaces of the first cloth layer.

The first elastic plate 416 is stacked on one surface of the first shim sheet 414 to elastically support the first shim sheet 414 against the first target sealing part between adjacent ring segments 340.

The first elastic plate 416 may be provided in various structures that may elastically support the first shim sheet 414 against the first target sealing part, and the present disclosure is neither limited nor restricted by the structure of the first elastic plate 416.

According to a preferred embodiment of the present disclosure, the first elastic plate 416 may include a first plate body 416a that is stacked on the first shim sheet 414, and a pair of first elastic edge parts 416b, each provided at a respective one of opposite side ends of the first plate body 416a, and configured to be bent so as to elastically support the first plate body 416a against the first target sealing part.

As an example, the first plate body 416a may be formed in a substantially rectangular plate shape corresponding to the first shim sheet 414, each of the pair of first elastic edge parts 416b may be continuously formed along a respective one of opposite side ends of the first plate body 416a, and the first plate body 416a and each of the first elastic edge parts 416b may be cooperatively connected to have a substantially “V”-shaped cross section.

In the above-described and illustrated embodiment of the present disclosure, an example, in which each of the pair of first elastic edge parts 416b is formed in a continuous band shape along a corresponding side end of the first plate body 416a, is described, but according to another embodiment of the present disclosure, it is also possible to form a plurality of first elastic edge parts on each side end of the first plate body 416a such that they are spaced apart from each other at specific intervals along the corresponding side ends of the first plate body.

With this structure, when the first sealing part 410 is interposed between adjacent ring segments 340, each of the pair of first elastic edge parts 416b may be moved toward the first plate body 416a and be compressed in a state of accumulating elastic force, and the first cloth layer 412 and the first shim sheet 414 may be elastically closely attached to the first target sealing part by the elastic force of the first elastic plate 416.

The second sealing part 420 is provided to seal a second target sealing part that is defined along a second direction that crosses the first direction between adjacent ring segments 340.

For reference, in the embodiment of the present disclosure, the second target sealing part may be defined as a portion (e.g., a surface to be sealed) that is sealed by the second sealing part 420.

The second target sealing part may be defined in various directions and structures depending on required conditions and design specifications, and the present disclosure is neither limited nor restricted by the direction (the direction of the second sealing part 420) and structure of the second target sealing part.

As an example, the second target sealing part may be defined in a substantially straight line along an axial direction (the second direction) of the turbine 300. According to another embodiment of the present disclosure, it is also possible to configure the second target sealing part such that it is inclined with respect to the radial direction of the turbine. Alternatively, the second target sealing part may be formed in a curved shape or another shape.

Hereinafter, an example, in which the second sealing part 420, corresponding to the second target sealing part, is disposed substantially perpendicular to the first sealing part 410, corresponding to the first target sealing part, will be described.

The second sealing part 420 may be provided in various structures that may seal or block the second target sealing part, and the present disclosure is neither limited nor restricted by the structure of the second sealing part 420.

According to a preferred embodiment of the present disclosure, the second sealing part 420 may include a second cloth layer 422 that is provided along the second direction, a second shim sheet 424 that is stacked on the second cloth layer 422, and a second elastic plate 426 that is stacked on the second shim sheet 424 to elastically support the second shim sheet 424 against the second target sealing part.

Preferably, the second sealing part 420 may be provided to have a width corresponding to that of the first sealing part 410. According to another embodiment of the present disclosure, it is also possible to configure the second sealing part 420 and the first sealing part 410 such that they have different widths.

The second cloth layer 422 is provided to provide flexibility to the second sealing part 420 while securing the sealing performance of the second sealing part 420.

The second cloth layer 422 may be formed of various materials having flexibility, and the present disclosure is neither limited nor restricted by the material and properties of the second cloth layer 422.

As an example, the second cloth layer 422 may include at least one of metal, ceramic, and/or polymer fibers that are woven, knitted, or pressed into a textile layer.

The second cloth layer 422 may be provided to have various structures according to required conditions and design specifications, and the present disclosure is neither limited nor restricted by the structure or shape of the first cloth layer 422.

As an example, the second cloth layer 422 may be provided in a substantially rectangular block shape.

The second shim sheet 424 is stacked on one surface of the second cloth layer 422 to form a double sealing structure together with the second cloth layer 422.

The second shim sheet 424 may be formed of various materials that may secure sealing performance, and the present disclosure is neither limited nor restricted by the material or properties of the second shim sheet 424.

As an example, the second shim sheet 424 may be formed of a general metal material. Preferably, the second shim sheet 424 may be formed by machining a thin metal plate to a thickness of 0.127 mm to provide flexibility such that the second sealing part 420 may effectively adhere to a surface of the second target sealing part.

The second shim sheet 424 may be provided in various structures that may be stacked on the second cloth layer 422, and the present disclosure is neither limited nor restricted by the structure of the second shim sheet 424.

According to a preferred embodiment of the present disclosure, the second shim sheet 424 may include a second shim sheet body part 424a that is stacked on the second cloth layer 422 and a pair of second shim sheet side parts 424b, each connected to a respective one of opposite side ends of the second shim sheet body part 424a to cover side surfaces of the second cloth layer 422.

As an example, the second shim sheet body part 424a may be formed in a substantially rectangular plate shape corresponding to the second cloth layer 422, each of the pair of second shim sheet side parts 424b may be continuously formed along a respective one of opposite side ends of the second shim sheet body part 424a, and the second shim sheet body part 424a and each of the pair of second shim sheet side parts 424b may be cooperatively connected to each other to have a substantially “L”-shaped cross section.

In the above-described and illustrated embodiment of the present disclosure, an example, in which each of the pair of second shim sheet side parts 424b is continuously formed along a respective one of opposite side ends of the second shim sheet body part 424a to entirely cover side surfaces of the second cloth layer 422, is described, but according to another embodiment of the present disclosure, it is also possible to configure each of the pair of second shim sheet side parts such that it partially covers the side surfaces of the second cloth layer.

The second elastic plate 426 is stacked on one surface of the second shim sheet 424 to elastically support the second shim sheet 424 against the second target sealing part between adjacent ring segments 340.

The second elastic plate 426 may be provided in various structures that may elastically support the second shim sheet 424 against the second target sealing part, and the present disclosure neither limited nor restricted by the structure of the second elastic plate 426.

According to a preferred embodiment of the present disclosure, the second elastic plate 426 may include a second plate body 426a that is stacked on the second shim sheet 424, and a pair of second elastic edge parts 426b, each provided at a respective one of opposite side ends of the second plate body 426a, and configured to be bent so as to elastically support the second plate body 426a against the second target sealing part.

As an example, the second plate body 426a may be formed in a substantially rectangular plate shape corresponding to the second shim sheet 424, each of the pair of second elastic edge parts 426b may be continuously formed along a respective one of opposite side ends of the second plate body 426a, and the second plate body 426a and each of the pair of second elastic edge parts 426a may be cooperatively connected to have a substantially “V”-shaped cross section.

In the above-described and illustrated embodiment of the present disclosure, an example, in which each of the pair of second elastic edge parts 426b is formed in a continuous band shape along the corresponding side end of the second plate body 426a, is described, but according to another embodiment of the present disclosure, it is also possible to form a plurality of second elastic edge parts on each side end of the second plate body 426a such that they are spaced apart from each other at specific intervals along the corresponding side ends of the second plate body 426a.

With this structure, when the second sealing part 420 is interposed between adjacent ring segments 340, each of the pair of second elastic edge parts 426b may be moved toward the second plate body 426a and be compressed in a state of accumulating elastic force, and the second cloth layer 422 and the second shim sheet 424 may be elastically closely attached to the second target sealing part by the elastic force of the second elastic plate 426.

The first extending sealing part 418 integrally extends from an end of a first sealing part 410 and may be bent so as to cover a gap between the first target sealing part and a second target sealing part, that is, a gap between the first sealing part 410 and the second sealing part 420, and the first sealing part 410 and the second sealing part 420 may be structurally connected to each other via the first extending sealing part 418.

According to a preferred embodiment of the present disclosure, the first extending sealing part 418 may integrally extend from an end (e.g., an end of the first shim sheet body part) of the first shim sheet 414.

In the above-described and illustrated embodiment of the present disclosure, an example, in which the first extending sealing part 418 integrally extends from an end of the first shim sheet 414, is described, but according to another embodiment of the present disclosure, it is also possible to configure the first extending sealing part such that it extends from an end of the first elastic plate 416.

The first extending sealing part 418 may be provided in various structures that extend from an end of the first shim sheet body part 414a to cover the gap between the first sealing part 410 and the second sealing part 420, and the present disclosure is neither limited nor restricted by the structure or shape of the first extending sealing part 418.

As an example, the first extending sealing part 418 may be provided to have a width corresponding to the first shim sheet body part 414a, and the first extending sealing part 418 may be bent at approximately 90 degrees with respect to the first shim sheet body part 414a.

In this way, by configuring the first extending sealing part 418 such that it has a width corresponding to the first shim sheet body part 414a which, for example, may match the width of the second sealing part 420, it is possible to minimize a gap between the first sealing part 410 and the second sealing part 420 and to minimize leakage of combustion gas.

The first sealing part 410 and the second sealing part 420 are structurally connected to each other via the first extending sealing part 418.

Here, the expression that “the first sealing part 410 and the second sealing part 420 are structurally connected to each other via the first extending sealing part 418” may be understood to mean that the first sealing part 410 and the second sealing part 420 are modularized into a single component via the first extending sealing part 418.

The first extending sealing part 418 may be connected to various portions of the second sealing part 420 according to required conditions and design specifications, and the present disclosure is neither limited nor restricted by a connection portion of the second sealing part 420, to which the first extending sealing part 418 is connected.

According to a preferred embodiment of the present disclosure, the first extending sealing part 418 may be supported by the second elastic plate 426.

The first extending sealing part 418 may be connected to the second elastic plate 426 in various ways depending on required conditions and design specifications, and the present disclosure is neither limited nor restricted by the connection structure between the first extending sealing part 418 and the second elastic plate 426.

According to a preferred embodiment of the present disclosure, the first extending sealing part 418 may be inserted between the second plate body 426a and the pair of second elastic edge parts 426b to structurally connect the first sealing part 410 and the second sealing part 420.

In this way, in the embodiment of the present disclosure, because the first extending sealing part 418 is inserted between the second plate body 426a that are provided to elastically support the second shim sheet 424 against the second target sealing part and the pair of second elastic edge parts 426b, there is no need to additionally provide a separate structure or component for structurally connecting the first extending sealing part 418 and the second elastic plate 426, so that the connection structure between the first extending sealing part 418 and the second elastic plate 426 may be simplified and the manufacturing and assembly processes may be simplified.

Meanwhile, in the above-described and illustrated embodiment of the present disclosure, an example, in which the first extending sealing part 418 is inserted between the second plate body 426a and the pair of second elastic edge parts 426b, is described, but according to another embodiment of the present disclosure, it is also possible to connect the first extending sealing part to the second sealing part via a separate fastening member.

According to a preferred embodiment of the present disclosure, the sealing assembly 20 may include a third sealing part 430 that seals a third target sealing part that is defined along a third direction that crosses the second direction and is provided adjacent to an end of the second sealing part 420 for connection thereto.

The third sealing part 430 is provided to seal a third target sealing part that is defined along the third direction that crosses the second direction between adjacent ring segments 340.

For reference, in the embodiment of the present disclosure, the third target sealing part may be defined as a portion (e.g., a surface to be sealed) that is sealed by the third sealing part 430.

The third target sealing part may be defined in various directions and structures depending on required conditions and design specifications, and the present disclosure is neither limited nor restricted by the direction (the direction of the third sealing part 430) and structure of the third target sealing part.

As an example, the third target sealing part may be defined in a substantially straight line along an axial direction (the third direction) of the turbine 300. According to another embodiment of the present disclosure, it is also possible to configure the third target sealing part such that it is inclined with respect to the radial direction of the turbine. Alternatively, the third target sealing part may be formed in a curved shape or another shape.

Hereinafter, an example, in which the third sealing part 430 corresponding to the third target sealing part is disposed substantially parallel to the first sealing part 410 corresponding to the first target sealing part will be described.

The third sealing part 430 may be provided in various structures that may seal or block the third target sealing part, and the present disclosure is neither limited nor restricted by the structure of the third sealing part 430.

According to a preferred embodiment of the present disclosure, the third sealing part 430 may include a third cloth layer 432 that is provided along the third direction, a third shim sheet 434 that is stacked on the third cloth layer 432, and a third elastic plate 436 that is stacked on the third shim sheet 434 to elastically support the third shim sheet 434 against the third target sealing part.

The third cloth layer 432 is provided to impart flexibility to the third sealing part 430 while securing the sealing performance of the third sealing part 430.

The third cloth layer 432 may be formed of various materials having flexibility, and the present disclosure is neither limited nor restricted by the material or properties of the third cloth layer 432.

As an example, the third cloth layer 432 may include at least one of metal, ceramic, and/or polymer fibers that are woven, knitted, or pressed into a textile layer.

The third cloth layer 432 may be provided to have various structures according to required conditions and design specifications, and the present disclosure is neither limited nor restricted by the structure or shape of the third cloth layer 432.

As an example, the third cloth layer 432 may be provided in a substantially rectangular block shape.

The third shim sheet 434 is stacked on one surface of the third cloth layer 432 to form a double sealing structure together with the third cloth layer 432.

The third shim sheet 434 may be formed of various materials that may secure sealing performance, and the present disclosure is neither limited nor restricted by the material or properties of the third shim sheet 434.

As an example, the third shim sheet 434 may be formed of a general metal material. Preferably, the third shim sheet 434 may be formed by machining a thin metal plate to a thickness of 0.127 mm to provide flexibility such that the third sealing part 430 may effectively adhere to a surface of the third target sealing part.

The third shim sheet 434 may be provided in various structures that may be stacked on the third cloth layer 432, and the present disclosure is neither limited nor restricted by the structure of the third shim sheet 434.

According to a preferred embodiment of the present disclosure, the third shim sheet 434 may include a third shim sheet body part 434a that is stacked on the third cloth layer 432 and a pair of third shim sheet side parts 434b, each connected to a respective one of opposite side ends of the third shim sheet body part 434a to cover side surfaces of the third cloth layer 432.

As an example, the third shim sheet body part 434a may be formed in a substantially rectangular plate shape corresponding to the third cloth layer 432, each of the pair of third shim sheet side part 434b may be continuously formed along a respective one of opposite side ends of the third shim sheet body part 434a, and the third shim sheet body part 434a and each of the pair of third shim sheet side parts 434b may be cooperatively connected to each other to have a substantially “L”-shaped cross section.

In the above-described and illustrated embodiment of the present disclosure, an example, in which each of the pair of third shim sheet side parts 434b is continuously formed along a respective one of opposite side ends of the third shim sheet body part 434a to entirely cover side surfaces of the third cloth layer 432, is described, but according to another embodiment of the present disclosure, it is also possible to configure each of the third shim sheet side parts 434b such that it partially covers the corresponding side surface of the third cloth layer.

The third elastic plate 436 is stacked on one surface of the third shim sheet 434 to elastically support the third shim sheet 434 against the third target sealing part between adjacent ring segments 340.

The third elastic plate 436 may be provided in various structures that may elastically support the third shim sheet 434 against the third target sealing part, and the present disclosure is neither limited nor restricted by the structure of the third elastic plate 436.

According to a preferred embodiment of the present disclosure, the third elastic plate 436 may include a third plate body 436a that is stacked on the third shim sheet 434, and a pair of third elastic edge parts 436b, each provided at a respective one of opposite side ends of the third plate body 436a, and configured to be bent so as to elastically support the third plate body 436a against the third target sealing part.

As an example, the third plate body 436a may be formed in a substantially rectangular plate shape corresponding to the third shim sheet 434, each of the pair of third elastic edge parts 436b may be continuously formed along a respective one of opposite side ends of the third plate body 436a, and the third plate body 436a and each of the pair of third elastic edge parts 436a may be cooperatively connected to have a substantially “V”-shaped cross section.

In the above-described and illustrated embodiment of the present disclosure, an example, in which each of the pair of third elastic edge parts 436b is formed in a continuous band shape along the corresponding side end of the third plate body 436a, is described, but according to another embodiment of the present disclosure, it is also possible to form a plurality of third elastic edge parts on each side end of the third plate body 436a such that they are spaced apart from each other at specific intervals along the corresponding side ends of the third plate body 436a.

With this structure, when the third sealing part 430 is interposed between adjacent ring segments 340, each of the pair of third elastic edge parts 436b may be moved toward the third plate body 436a and be compressed in a state of accumulating elastic force, and the third cloth layer 432 and the third shim sheet 434 may be elastically closely attached to the third target sealing part by the elastic force of the third elastic plate 436.

According to a preferred embodiment of the present disclosure, the sealing assembly 20 may include a second extending sealing part 438 that integrally extends from an end of the third sealing part 430, is configured to be bent to cover a gap between the second sealing part 420 and the third sealing part 430, and is connected to the second sealing part 420.

The second extending sealing part 438 may integrally extend from an end of the third sealing part 430 and may be bent to cover a gap between the second target sealing part and the third target sealing part, that is, a gap between the second sealing part 420 and the third sealing part 430, and the second sealing part 420 and the third sealing part 430 may be structurally connected to each other via the second extending sealing part 438.

According to a preferred embodiment of the present disclosure, the second extending sealing part 438 may integrally extend from an end (e.g., an end of the third shim sheet body part) of the third shim sheet 434.

In the above-described and illustrated embodiment of the present disclosure, an example, in which the second extending sealing part 438 integrally extends from an end of the third shim sheet 434, is described, but according to another embodiment of the present disclosure, it is also possible to configure the third extending sealing part such that it extends from an end of the third elastic plate 436.

The second extending sealing part 438 may be provided in various structures that extend from an end of the third shim sheet body part 434a to cover the gap between the third sealing part 430 and the second sealing part 420, and the present disclosure is neither limited nor restricted by the structure or shape of the second extending sealing part 438.

As an example, the second extending sealing part 438 may be provided to have a width corresponding to the third shim sheet body part 434a, and the second extending sealing part 438 may be bent at approximately 90 degrees with respect to the third shim sheet body part 434a.

In this way, by configuring the second extending sealing part 438 such that it has a width corresponding to the third shim sheet body part 434a which, for example, may match the width of the third sealing part 430, it is possible to minimize a gap between the second sealing part 420 and the third sealing part 430 and to minimize leakage of combustion gas.

The second sealing part 420 and the third sealing part 430 are structurally connected to each other via the second extending sealing part 438.

Here, the expression that “the second sealing part 420 and the third sealing part 430 are structurally connected to each other via the second extending sealing part 438” may be understood to mean that the second sealing part 420 and the third sealing part 430 are modularized into a single component via the second extending sealing part 438.

The second extending sealing part 438 may be connected to various portions of the second sealing part 420 according to required conditions and design specifications, and the present disclosure is neither limited nor restricted by a connection portion of the second sealing part 420, to which the second extending sealing part 438 is connected.

According to a preferred embodiment of the present disclosure, the second extending sealing part 438 may be supported by the second elastic plate 426.

The second extending sealing part 438 may be connected to the second elastic plate 426 in various ways depending on required conditions and design specifications, and the present disclosure is neither limited nor restricted by the connection structure between the second extending sealing part 438 and the second elastic plate 426.

According to a preferred embodiment of the present disclosure, the second extending sealing part 438 may be inserted between the second plate body 426a and the pair of second elastic edge parts 426b to structurally connect the third sealing part 430 and the second sealing part 420.

In this way, in the embodiment of the present disclosure, because the second extending sealing part 438 is inserted between the second plate body 426a that are provided to elastically support the second shim sheet 424 against the second target sealing part and the pair of second elastic edge parts 426b, there is no need to additionally provide a separate structure or component for structurally connecting the second extending sealing part 438 and the second elastic plate 426, so that the connection structure between the second extending sealing part 438 and the second elastic plate 426 may be simplified and the manufacturing and assembly processes may be simplified.

According to a preferred embodiment of the present disclosure, the sealing assembly 20 may include peripheral sealing parts 510 and 520 that cooperate with the above-described first sealing part 410, second sealing part 420, and third sealing part 430 to seal between adjacent ring segments 340.

The structure and number of the peripheral sealing parts 510 and 520 may be variously modified according to required conditions and design specifications, and the present disclosure is neither limited nor restricted by the structure and number of the peripheral sealing parts 510 and 520.

Meanwhile, in the above-described and illustrated embodiment of the present disclosure, an example, in which the second extending sealing part 438 is inserted between the second plate body 426a and the pair of second elastic edge parts 426b, is described, but according to another embodiment of the present disclosure, it is also possible to connect the second extending sealing part to the second sealing part via a separate fastening member.

Furthermore, in the above-described and illustrated embodiment of the present disclosure, an example, in which the second extending sealing part 438 that covers the gap between the second sealing part 420 and the third sealing part 430 extends from an end of the third sealing part 430, is described, but, according to another embodiment of the present disclosure, it is also possible to form the second extending sealing part for covering the gap between the second sealing part 420 and the third sealing part 430 at an end of the second sealing part 420.

As described above, according to the present disclosure, the structure and the assembling process may be simplified and the sealing performance may be enhanced.

In particular, according to the present disclosure, the structure and manufacturing efforts may be simplified while the sealing performance between adjacent components of the turbine is secured.

Above all, according to the present disclosure, the gap between the sealing members that cross each other may be effectively sealed without additionally providing a separate blocking member (an additional sealing member) for blocking the gap between the sealing members that cross each other.

Furthermore, according to the present disclosure, costs may be saved, and stability and reliability may be enhanced.

Although the embodiments have been mainly described above, they are simply examples and are not intended to limit the present disclosure, and it may be understood by those skilled in the art, to which the present disclosure pertains, that various modifications and applications that have not been described above may be possible without departing from essential characteristics of the embodiment. For example, the components that appear in detail in the embodiment may be carried out after being modified. Furthermore, it should be construed that the differences related to the modifications and applications are included in the scope of the present disclosure, which is defined in the attached claims.

What is claimed is:

1. A sealing assembly comprising:
a first sealing part configured to seal a first target sealing part defined along a first direction;
a second sealing part configured to seal a second target sealing part defined along a second direction crossing the first direction, and provided adjacent to an end of the first sealing part for connection thereto; and
a first extending sealing part integrally extending from the end of the first sealing part, configured to be bent, disposed to cover a gap between the first sealing part and the second sealing part, and connected to the second sealing part.

2. The sealing assembly of claim 1, wherein the first sealing part includes:
a first cloth layer provided along the first direction;
a first shim sheet stacked on the first cloth layer; and
a first elastic plate stacked on the first shim sheet, and configured to elastically support the first shim sheet against the first target sealing part, and
wherein the first extending sealing part integrally extends from an end of the first shim sheet.

3. The sealing assembly of claim 2, wherein the first shim sheet includes:
a first shim sheet body part stacked on the first cloth layer; and
a pair of first shim sheet side parts, each connected to a respective one of opposite side ends of the first shim sheet body part to cover side surfaces of the first cloth layer.

4. The sealing assembly of claim 2, wherein the first elastic plate includes:
a first plate body stacked on the first shim sheet; and
a pair of first elastic edge parts, each provided at a respective one of opposite side ends of the first plate body, and configured to be bent and to elastically support the first plate body against the first target sealing part.

5. The sealing assembly of claim 2, wherein the second sealing part includes:
a second cloth layer provided along the second direction;
a second shim sheet stacked on the second cloth layer; and
a second elastic plate stacked on the second shim sheet, and configured to elastically support the second shim sheet against the second target sealing part, and
wherein the first extending sealing part is supported by the second elastic plate.

6. The sealing assembly of claim 5, wherein the second elastic plate includes:
a second plate body stacked on the second shim sheet; and
a pair of second elastic edge parts, each provided at a respective one of opposite side ends of the second plate body, and configured to be bent and to elastically support the second plate body against the second target sealing part, and
wherein the first extending sealing part is inserted between the second plate body and the pair of second elastic edge parts.

7. The sealing assembly of claim 5, wherein the second shim sheet includes:
a second shim sheet body part stacked on the second cloth layer; and
a pair of second shim sheet side parts, each connected to a respective one of opposite side ends of the second shim sheet body part to cover side surfaces of the second cloth layer.

8. The sealing assembly of claim 6, further comprising:
a third sealing part configured to seal a third target sealing part defined along a third direction crossing the second direction, and provided adjacent to an end of the second sealing part for connection thereto.

9. The sealing assembly of claim 8, further comprising:
a second extending sealing part integrally extending from an end of the third sealing part, configured to be bent, disposed to cover a gap between the second sealing part and the third sealing part, and connected to the second sealing part.

10. The sealing assembly of claim 9, wherein the third sealing part includes:
a third cloth layer provided along the third direction;
a third shim sheet stacked on the third cloth layer; and
a third elastic plate stacked on the third shim sheet, and configured to elastically support the third shim sheet against the third target sealing part, and
wherein the second extending sealing part integrally extends from an end of the third shim sheet.

11. The sealing assembly of claim 10, wherein the second extending sealing part is inserted between the second plate body and the second elastic edge part.

12. The sealing assembly of claim 10, wherein the third shim sheet includes:
a third shim sheet body part stacked on the third cloth layer; and
a pair of third shim sheet side parts, each connected to a respective one of opposite side ends of the third shim sheet body part to cover side surfaces of the third cloth layer.

13. The sealing assembly of claim 10, wherein the third elastic plate includes:
a third plate body stacked on the third shim sheet; and
a pair of third elastic edge parts, each provided at a respective one of opposite side ends of the third plate body, and configured to be bent and to elastically support the third plate body against the third target sealing part.

14. A sealing assembly comprising:
a first sealing part configured to seal a first target sealing part defined along a first direction;
a second sealing part configured to seal a second target sealing part defined along a second direction crossing the first direction, and provided adjacent to an end of the first sealing part for connection thereto;
a third sealing part configured to seal a third target sealing part defined along a third direction crossing the second direction, and provided adjacent to an end of the second sealing part for connection thereto;
a first extending sealing part integrally extending from the end of the first sealing part, configured to be bent, disposed to cover a gap between the first sealing part and the second sealing part, and connected to the second sealing part; and
a second extending sealing part integrally extending from an end of the third sealing part, configured to be bent, disposed to cover a gap between the second sealing part and the third sealing part, and connected to the second sealing part.

15. The sealing assembly of claim 14, wherein the first sealing part includes a first cloth layer provided along the first direction, a first shim sheet having the first extending sealing part integrally extending from one end thereof and stacked on the first cloth layer, and a first elastic plate stacked on the first shim sheet and configured to elastically support the first shim sheet against the first target sealing part,
wherein the second sealing part includes a second cloth layer provided along the second direction, a second shim sheet stacked on the second cloth layer, and a second elastic plate stacked on the second shim sheet and configured to elastically support the second shim sheet against the second target sealing part, and
wherein the third sealing part includes a third cloth layer provided along the third direction, a third shim sheet having the second extending sealing part integrally extending from one end thereof and stacked on the third cloth layer, and a third elastic plate stacked on the third shim sheet and configured to elastically support the third shim sheet against the third target sealing part, and
wherein the first extending sealing part and the second extending sealing part are each supported by the second elastic plate.

16. The sealing assembly of claim 15, wherein the second elastic plate includes:
a second plate body stacked on the second shim sheet; and
a pair of second elastic edge parts, each provided at a respective one of opposite side ends of the second plate body, and configured to be bent and to elastically support the second plate body against the second target sealing part, and
wherein the first extending sealing part and the second extending sealing part are inserted between the second plate body and the pair of second elastic edge parts.

17. A gas turbine comprising:
a compressor configured to suck in and compress air;
a burner configured to mix the air compressed in the compressor and fuel to burn the fuel;
a turbine including a turbine casing, a plurality of turbine vanes provided on an inner surface of the turbine casing along a circumferential direction thereof, and a plurality of ring segments provided on an inner surface of the turbine casing along the circumferential direction thereof to face turbine blades that are rotatably provided in the interior of the turbine casing, and configured to rotate the turbine blades by combustion gas discharged from the burner;
a first sealing part configured to seal a first target sealing part defined between adjacent ring segments of the plurality of ring segments or adjacent turbine vanes of the plurality of turbine vanes along a first direction;
a second sealing part configured to seal a second target sealing part defined between the adjacent ring segments or the adjacent turbine vanes along a second direction crossing the first direction, and provided adjacent to an end of the first sealing part for connection thereto; and
a first extending sealing part integrally extending from the end of the first sealing part, configured to be bent, disposed to cover a gap between the first sealing part and the second sealing part, and connected to the second sealing part.

18. The gas turbine of claim 17, wherein the first sealing part includes:
a first cloth layer provided along the first direction;
a first shim sheet stacked on the first cloth layer; and
a first elastic plate stacked on the first shim sheet, and configured to elastically support the first shim sheet against the first target sealing part, and
wherein the first extending sealing part integrally extends from an end of the first shim sheet.

19. The gas turbine of claim 18, wherein the second sealing part includes:
a second cloth layer provided along the second direction;
a second shim sheet stacked on the second cloth layer; and
a second elastic plate stacked on the second shim sheet, and configured to elastically support the second shim sheet against the second target sealing part, and
wherein the first extending sealing part is supported by the second elastic plate.

20. The gas turbine of claim 19, wherein the second elastic plate includes:
a second plate body stacked on the second shim sheet;
a pair of second elastic edge parts, each provided at a respective one of opposite side ends of the second plate body, and configured to be bent and to elastically support the second plate body against the second target sealing part, and
wherein the first extending sealing part is inserted between the second plate body and the pair of second elastic edge parts.
